(19) United States
(12) Patent Application Publication
(10) Pub. No.: US 2014/0168396 A1
(43) Pub. Date: Jun. 19, 2014

(54) METHOD FOR VIEWING CONTENTS OF A REFRIGERATOR APPLIANCE

(71) Applicant: GENERAL ELECTRIC COMPANY, Schenectady, NY (US)

(72) Inventors: Michael John Kempiak, Osceola, IN (US); Joel Erik Hitzelberger, Louisville, KY (US); Bahman Abbasi, Louisville, KY (US)

(73) Assignee: GENERAL ELECTRIC COMPANY, Schenectady, NY (US)

(21) Appl. No.: 13/718,021

(22) Filed: Dec. 18, 2012

(51) Int. Cl. H04N 7/18

(52) U.S. Cl. CPC H04N 7/18
USPC 348/61

(57) ABSTRACT

A method for viewing contents of a refrigerator appliance is provided. The method includes obtaining a series of pictures of a chilled chamber of the refrigerator appliance over a period of time. The method also includes selecting at least two of the pictures and displaying the at least two pictures to a user. The method can assist the user with establishing an inventory of food articles positioned within the chilled chamber.

### FIELD OF THE INVENTION

The present subject matter relates generally to refrigerator appliances.

### BACKGROUND OF THE INVENTION

Refrigerator appliances generally include a cabinet that defines a chilled chamber. A user can place food items within the chilled chamber in order to hinder perishing of such food items. Thereby, a useable life of perishable food items can be increased.

Over time, a large volume of food items can accumulate within the refrigerator's chilled chamber. As food items accumulate, refrigerator appliance users can have difficulty identifying food items located within the refrigerator appliance or determining a quantity of certain food items within the refrigerator appliance. Consequently, the users may purchase replacement or additional food items despite already having such food items or a sufficient amount of such food items. In particular, certain food items do not readily perish within the chilled chamber, and such food items may be consumed infrequently. Thus, such food items can remain within the chilled chamber for extended periods of time. The users can forget about such food items and purchase replacements despite already having acceptable items. In such manner, the users can be inconvenienced or expend money needlessly.

Accordingly, a refrigerator appliance with features for assisting a user with viewing contents of a chilled chamber of the refrigerator appliance would be useful. In particular, a refrigerator appliance with features for assisting a user with viewing contents of a chilled chamber of the refrigerator appliance in order to establish an inventory of food items positioned within the chilled chamber would be useful.

### BRIEF DESCRIPTION OF THE INVENTION

The present subject matter provides a method for viewing contents of a refrigerator appliance. The method includes obtaining a series of pictures of a chilled chamber of the refrigerator appliance over a period of time. The method also includes selecting at least two of the pictures and displaying the at least two pictures to a user. The method can assist the user with establishing an inventory of food articles positioned within the chilled chamber. Additional aspects and advantages of the invention will be set forth in part in the following description, or may be apparent from the description, or may be learned through practice of the invention.

In a first exemplary embodiment, a method for viewing contents of a refrigerator appliance is provided. The method includes: obtaining a series of pictures of a chilled chamber of a refrigerator appliance over a period of time; selecting at least two pictures of the series of pictures; and displaying the at least two pictures to a user in order to assist the user with establishing an inventory of food articles positioned within the chilled chamber or determining a freshness of food articles positioned within the chilled chamber.

In a second exemplary embodiment, a refrigerator appliance is provided. The refrigerator appliance includes a cabinet defining a chilled chamber for receipt of food items for storage. A camera is directed towards the chilled chamber of the cabinet. The camera is configured for taking pictures of the chilled chamber of the cabinet. A controller is in communication with the camera. The controller is configured: for obtaining a series of pictures of the chilled chamber of the cabinet from the camera over a period of time; selecting at least two pictures of the series of pictures; and providing the at least two pictures to a user in order to assist the user with establishing an inventory of food articles positioned within the chilled chamber or determining a freshness of food articles positioned within the chilled chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front, elevation view of a refrigerator appliance according to an exemplary embodiment of the present subject matter.

FIG. 2 provides a front, elevation view of the refrigerator appliance of FIG. 1. In FIG. 2, refrigerator doors of the refrigerator appliance are shown in an open position in order to reveal a fresh food chamber of the refrigerator appliance.

FIG. 3 provides a schematic view of the refrigerator appliance of FIG. 1. The refrigerator appliance includes a camera.

FIGS. 4-9 illustrate a series of pictures of the fresh food chamber of the refrigerator appliance of FIG. 1 taken with the camera of the refrigerator appliance.

FIG. 10 illustrates a method for viewing contents of a refrigerator appliance according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

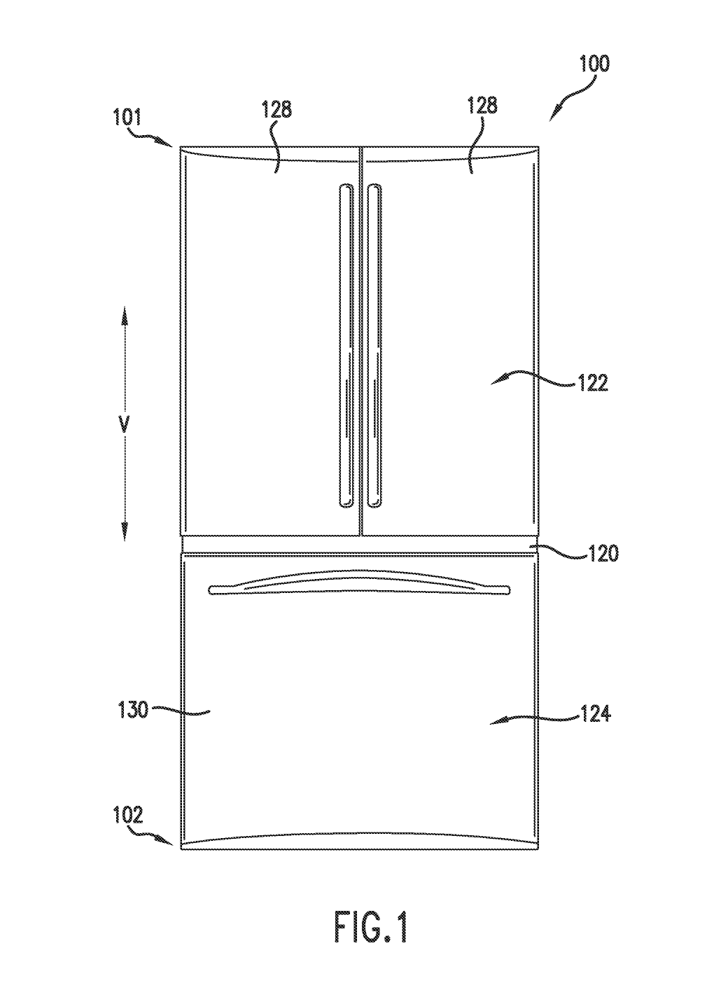

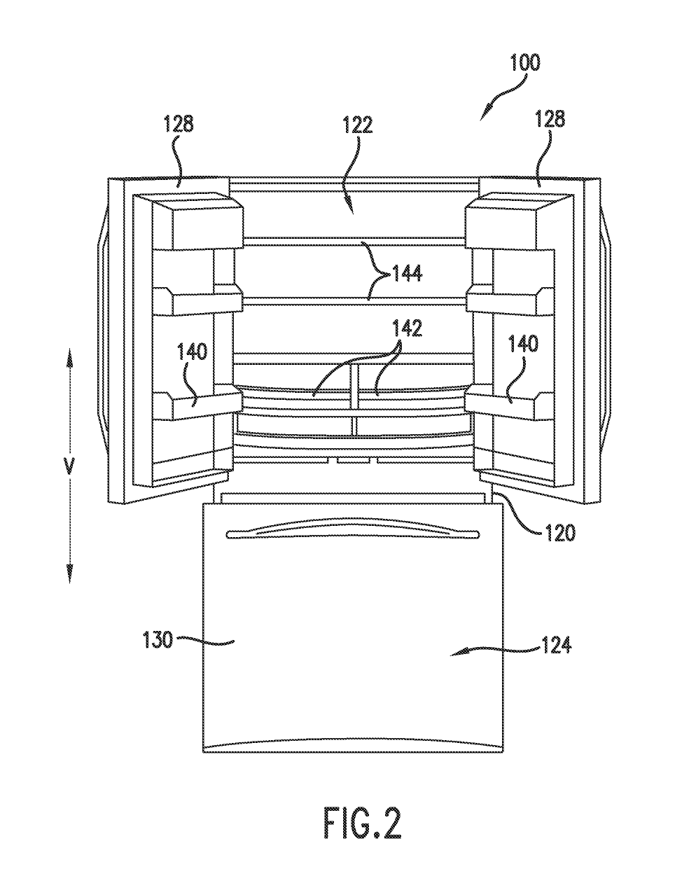

FIG. 1 provides a front, elevation view of a refrigerator appliance 100 according to an exemplary embodiment of the present subject matter with refrigerator doors 128 of the refrigerator appliance 100 shown in a closed position. FIG. 2 provides a front view of refrigerator appliance 100 with refrigerator doors 128 shown in an open position to reveal a fresh food chamber 122 of refrigerator appliance 100.

Refrigerator appliance 100 includes a cabinet or housing 120 that extends between a top 101 and a bottom 102 along a vertical direction V. Housing 120 defines chilled chambers for receipt of food items for storage. In particular, housing 120 defines fresh food chamber 122 positioned at or adjacent top 101 of housing 120 and a freezer chamber 124 arranged at or adjacent bottom 102 of housing 120. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

Refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. As discussed above, refrigerator doors 128 and freezer door 130 are shown in the closed configuration in FIG. 1, and refrigerator doors 128 are shown in the open position in FIG. 2.

Turning now to FIG. 2, various storage components are mounted within fresh food chamber 122 to facilitate storage of food items therein as will be understood by those skilled in the art. In particular, the storage components include bins 140, drawers 142, and shelves 144 that are mounted within fresh food chamber 122. Bins 140, drawers 142, and shelves 144 are configured for receipt of food items (e.g., beverages and/or solid food items) and may assist with organizing such food items. As an example, drawers 142 can receive fresh food items (e.g., vegetables, fruits, and/or cheeses) and increase the useful life of such fresh food items.

Refrigerator appliance 100 also includes features for assisting a user with identifying food items positioned within fresh food chamber 122 and/or freezer chamber 124. The user can utilize such features, e.g., to view food items stored within fresh food chamber 122 and/or freezer chamber 124 or create an inventory of such food items. Such features are discussed in greater detail below.

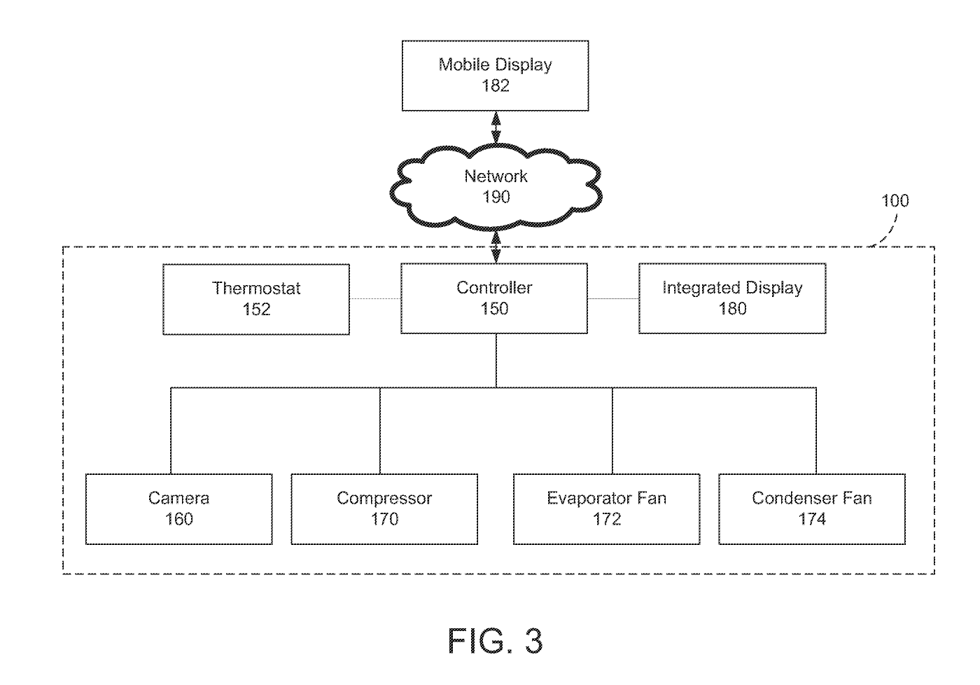

FIG. 3 provides a schematic view of refrigerator appliance 100. Refrigerator appliance 10 includes a controller 150 that is operatively coupled or in communication with components of a refrigeration system (not shown) of refrigerator appliance 100 configured for cooling fresh food chamber 122 and/or freezer chamber 124. The components include a compressor 170, an evaporator fan 172, and a condenser fan 174. Controller 150 can selectively operate such components in order to cool fresh food chamber 122 and/or freezer chamber 124. Controller 150 is also in communication with a thermostat 152, e.g., a thermocouple or thermistor. Thermostat 152 may be positioned in fresh food compartment 122 or freezer compartment 124 (FIG. 2). Controller 150 may receive a signal from thermostat 152 that corresponds to a temperature of fresh food compartment 122 and/or freezer compartment 124. Controller 150 may also include an internal timer for calculating elapsed time periods.

Controller 150 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor.

Controller 150 may be positioned in a variety of locations throughout refrigerator appliance 100. Input/output (“I/O”) signals may be routed between controller 150 and various operational components of refrigerator appliance 100. The components of refrigerator appliance 100 may be in communication with controller 150 via one or more signal lines or shared communication busses.

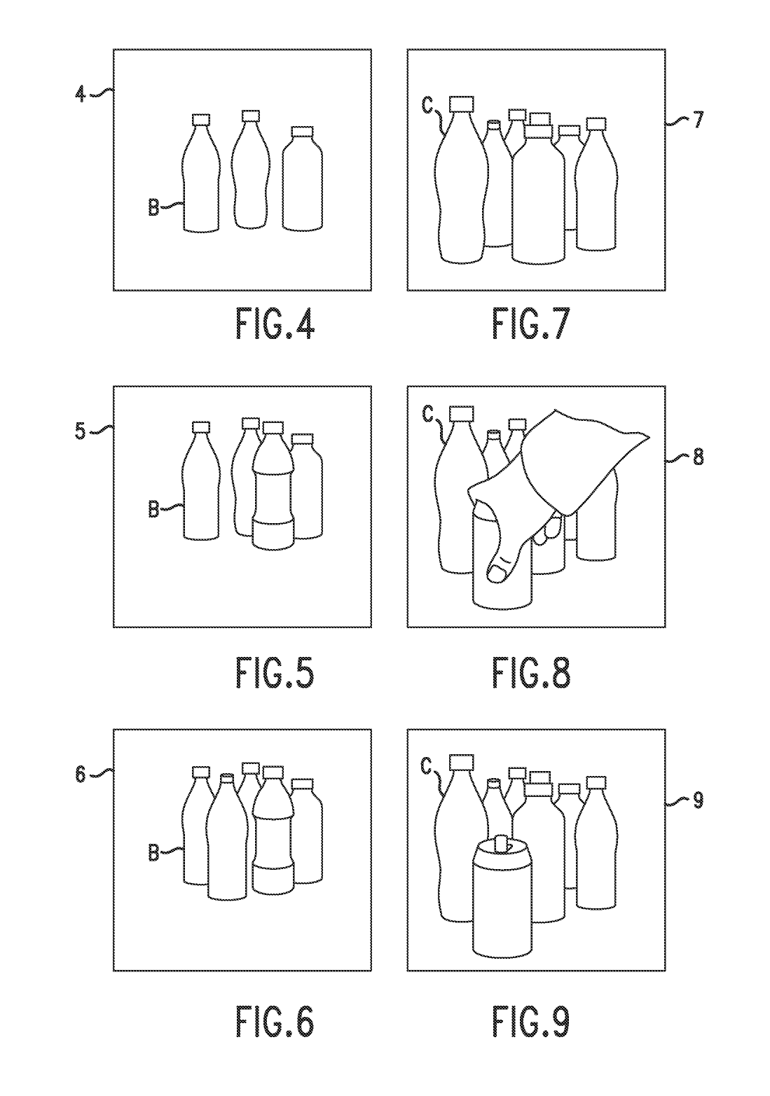

Refrigerator appliance 100 also includes a camera 160. Camera 160 may be any type of device suitable for capturing a picture, such as pictures 4-9 (FIGS. 4-9). As an example, camera 160 may be a video camera or a digital camera with an electronic image sensor, e.g., a charge coupled device (CCD) or a CMOS sensor. Camera 160 is in communication with controller 150 such that controller 150 may receive a signal from camera 160 corresponding to the picture captured by camera 160.

Camera 160 may be positioned at any suitable location on or within refrigerator appliance 100. For example, refrigerator appliance 100 may be positioned on refrigerator doors 128 and directed towards fresh food chamber 122 such that camera 160 captures pictures of fresh food chamber 122. In particular, camera 160 may be directed towards any particular one of or combination of bins 140, drawers 142, and shelves 144 (FIG. 2). Thus, camera 160 can capture pictures of one of bins 140, all of bins 140, one of drawers 142, all of drawers 142, one of shelves 144, all of shelves 144, or any suitable combination thereof. A plurality of cameras may be required to capture a picture of the entire fresh food chamber 122.

Refrigerator appliance 100 also includes an integrated display 180. Integrated display 180 may be mounted on refrigerator door 128 above dispenser 114 or at any other suitable location on refrigerator appliance 100. Integrated display 180 is in communication with controller 150 such that integrated display 180 may receive a signal from controller 150 corresponding to a picture captured by camera 160. Integrated display 180 can receive such signal from controller 150 and present the picture to a user visually. Integrated display 180 may include, for example, a liquid crystal display panel (LCD), a plasma display panel (PDP), or any other suitable mechanism for displaying a picture, e.g., a projector.

Refrigerator appliance 100 also includes a network interface (not shown) that couples refrigerator appliance 100, e.g., controller 150, to a network 190 such that refrigerator appliance 100 can transmit and receive information over network 190. Network 190 can be any wired or wireless network such as a WAN, LAN, and/or HAN.

Refrigerator appliance 100, e.g., controller 150, is in communication with a mobile display 182 via network 190. Mobile display 110 can be any device configured to communicate over network 190 and display pictures received therefrom. For example, mobile display 182 may be a computer, a smartphone, or a tablet. Mobile display 182 is in communication with controller 150 such that mobile display 182 may receive a signal from controller 150 (via network 190) corresponding to a picture captured by camera 160. Mobile display 182 can receive such signal from controller 150 and present the picture to a user visually. Like integrated display 180, mobile display 182 may include, for example, an LCD or PDP. Mobile display 182 can also include an interface that allows mobile display 182 to initiate communications with refrigerator appliance 100 over network 120.

FIGS. 4-9 illustrate a series of pictures of fresh food chamber 122 of refrigerator appliance 100 taken with camera 160 of refrigerator appliance 100 over a period of time, e.g., about a week, about a month, about two months, about six months, or more. In particular, the series of pictures is directed towards one of shelves 144. Pictures 4-9 of FIGS. 4-9, respectively, are taken sequentially such that picture 5 of FIG. 5 is taken after picture 4 of FIG. 4, picture 6 in FIG. 6 is taken after picture 5 in FIG. 5, and so forth.

Any picture of pictures 4-9 may be displayed to a user on integrated display 180 and/or mobile display 182. For example, a user at a remote location such as a grocery store may be unsure about whether the user has a particular food item. The user can utilize mobile display 182 to view a picture of the series of pictures in order to determine whether the food items is present on shelf 144.

As may be seen in FIGS. 4-9, food items accumulate on shelf 144 over the period of time. Due to such accumulation, food items at a back of shelf 144 can be concealed from camera 160 by food items at a front of shelf 144. As an example, a bottle B visible in picture 4 (FIG. 4) cannot be seen in picture 9 (FIG. 9) due to a bottle C sitting between bottle B and camera 160. Accordingly, a user presented with only picture 9 would be unaware of bottle B located behind bottle C on shelf 144. Thus, controller 150 can present the user with both pictures 4 and 9 of the series of pictures. However, viewing all pictures of series of pictures in order to determine contents of refrigerator appliance 100 can be tedious. Thus, as discussed in greater detail below, refrigerator appliance 100 includes features for assisting a user with viewing contents of refrigerator appliance 100, e.g., without having to view all pictures of the series of pictures.

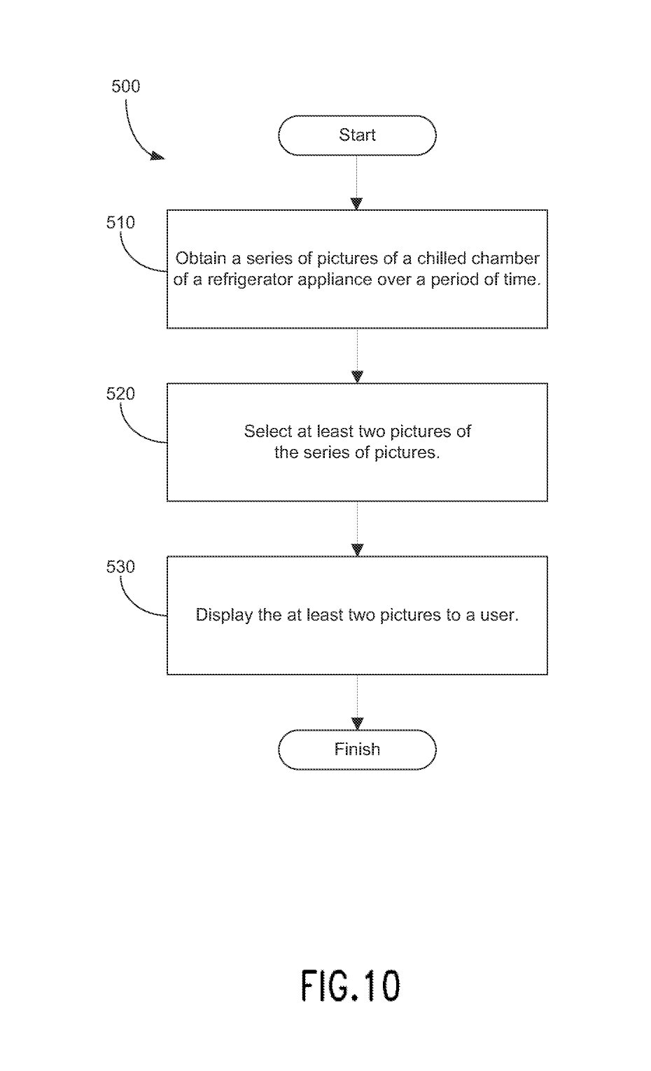

FIG. 10 illustrates a method 500 for viewing contents of a refrigerator appliance according to an exemplary embodiment of the present subject matter. Refrigerator appliance 100, e.g., controller 150, (FIG. 3) may be configured or programmed to implement method 500. As discussed in greater detail below, utilizing method 500 can assist a user with viewing contents of refrigerator appliance 100.

At step 510, controller 150 obtains a series of pictures of fresh food chamber 122 and/or freezer chamber 124 of refrigerator appliance 100 over a period of time and, e.g., stores the series of pictures in the memory or controller 150. As an example, at step 510, controller 150 can utilize camera 160 to obtain a picture of fresh food chamber 122 and/or freezer chamber 124 each time refrigerator doors 128 and/or freezer door 130 are opened or closed. Alternatively, at step 510, controller 150 can utilize camera 160 to obtain a picture of fresh food chamber 122 and/or freezer chamber 124 each time that a predetermined time interval elapses. The predetermined time interval can be any suitable time interval. For example, the predetermined timer interval can be about thirty minutes, about one hour, about two hours, about six hours, about twelve hours, about twenty-four hours, or between about thirty minutes and about twenty-four hours.

At step 520, controller 150 selects at least two pictures of the series of pictures. The at least two picture can be selected in order to show a majority of food articles located within fresh food chamber 122 and/or freezer chamber 124. For example, at step 520, controller 150 can compare sequential pictures of the series of pictures in order to determine if food articles have been removed from, added to, or repositioned within fresh food chamber 122 and/or freezer chamber 124. For example, picture 4 (FIG. 4) shows three bottles with each bottle visible. Similarly, picture 6 (FIG. 6) shows five bottles, but one of the bottles is difficult to see and identifying the hidden bottle can be difficult. Thus, at step 520, controller 150 can select both picture 4 and picture 6 in order to permit the user to see all bottles on shelf 144 up to the point in time picture 6 was taken.

At step 530, controller 150 displays the at least two pictures to a user. For example, controller 150 can send the at least two pictures to integrated display 180 and/or mobile display 182. Controller 150 can display the at least two picture at step 530 in order to assist the user with establishing an inventory of food articles positioned within fresh food chamber 122 and/or freezer chamber 124.

As an example, at step 520, controller 150 can select picture 4 (FIG. 4) and picture 9 (FIG. 9) of the series of pictures in order to show the majority of food items on shelf 144. By selecting such pictures, bottle B shown in picture 4 but not visible in picture 9 is displayed to the user. Thus, the user is presented with a picture where bottle B is visible despite the fact that it is currently obstructed from the view of camera 160 by bottle C. By properly selecting pictures from the series of pictures at step 520, controller 150 can present the user with pictures that display currently obstructed food items, e.g., without needlessly presenting all pictures of the series of pictures to the user.

Method 500 can also assist with determining a freshness of food articles positioned within fresh food chamber 122 and/or freezer chamber 124. For example, if certain food articles with fresh food chamber 122 and/or freezer chamber 124 have not moved for an extended period of time, such food items will remain within the series of pictures. Method 500 can assist with identifying such food items and alerting a user of such food items, e.g., by determining when such food items first appeared in the series of pictures. By know when such food items were placed into fresh food chamber 122 and/or freezer chamber 124, the user can evaluate a freshness of such food items.

In additional exemplary embodiments, controller 150 removes undesirable pictures from the series of pictures. Undesirable pictures have an unfocused object positioned within a foreground of the undesirable pictures. Picture 8 (FIG. 8) illustrates a user adding a bottle to shelf 144. The user's arm and hand block and obstruct much of picture 8. Thus, controller 150 can remove picture 8 from the series of pictures in order to prevent such obstructed views from being presented to the user at step 530.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer-implemented method for viewing contents of a refrigerator appliance, the method comprising:
obtaining a series of pictures of a chilled chamber of a refrigerator appliance over a period of time;
selecting at least two pictures of the series of pictures; and
displaying the at least two pictures to a user in order to assist the user with establishing an inventory of food articles positioned within the chilled chamber or determining a freshness of food articles positioned within the chilled chamber.

2. The method of claim 1, wherein said step of obtaining comprises taking a picture of the chilled chamber each time a door of the refrigerator appliance is opened or closed.

3. The method of claim 1, wherein said step of obtaining comprises taking a picture of the chilled chamber after a time interval has elapsed.

4. The method of claim 3, wherein the time interval is less than about twenty-four hours.

5. The method of claim 1, wherein the at least two picture show food articles positioned within the chilled chamber.

6. The method of claim 1, wherein said step of selecting comprises comparing sequential pictures of the series of pictures in order to determine if food articles have been removed from, added to, or repositioned within the chilled chamber.

7. The method of claim 1, further comprising removing undesirable pictures from the series of pictures, the undesirable pictures having an unfocused object positioned within a foreground of the undesirable pictures.

8. The method of claim 1, wherein the series of pictures are directed to a shelf or a drawer of the refrigerator appliance.

9. The method of claim 8, wherein the at least two picture show a majority of food articles received on said shelf or within said drawer.

10. The method of claim 1, wherein said step of displaying comprises sending the at least two images to a mobile display.

11. A refrigerator appliance, comprising:
a cabinet defining a chilled chamber for receipt of food items for storage;
a camera directed towards the chilled chamber of said cabinet, said camera configured for taking pictures of the chilled chamber of said cabinet; and
a controller in communication with said camera, said controller configured for:
obtaining a series of pictures of the chilled chamber of said cabinet from said camera over a period of time;
selecting at least two pictures of the series of pictures; and
providing the at least two pictures to a user in order to assist the user with establishing an inventory of food articles positioned within the chilled chamber or determining a freshness of food articles positioned within the chilled chamber.

12. The refrigerator appliance of claim 11, further comprising a door mounted to said cabinet in order to permit selective access to the chilled chamber of said cabinet, said camera mounted to said door.

13. The refrigerator appliance of claim 11, further comprising a door mounted to said cabinet in order to permit selective access to the chilled chamber of said cabinet, wherein said controller obtains a picture of the chilled chamber from said camera each time the door of the refrigerator appliance is opened or closed.

14. The refrigerator appliance of claim 11, further comprising a shelf or a drawer mounted within the chilled chamber of said cabinet and configured for receipt of food items, said camera directed towards said shelf or said drawer in order to take pictures of food items received on said shelf or within said drawer.

15. The refrigerator appliance of claim 14, wherein the at least two picture show food articles received on said shelf or within said drawer.

16. The refrigerator appliance of claim 11, wherein said controller obtains a picture of the chilled chamber from said camera after a time interval has elapsed during said step of obtaining.

17. The refrigerator appliance of claim 16, wherein the time interval is less than about twenty-four hours.

18. The refrigerator appliance of claim 11, wherein said step of providing comprises sending the at least two images to a mobile display.

19. The refrigerator appliance of claim 11, wherein said controller compares sequential pictures of the series of pictures in order to determine if food articles have been removed from, added to, or repositioned within the chilled chamber during said step of selecting.

20. The refrigerator appliance of claim 11, wherein said controller is further configured for removing undesirable pictures from the series of pictures, the undesirable pictures having an unfocused object positioned within a foreground of the undesirable pictures.
